(19) United States
(12) Patent Application Publication
(10) Pub. No.: US 2020/0301007 A1
(43) Pub. Date: Sep. 24, 2020

(54) RADAR-BASED RANGING PROCESSING METHOD AND DEVICE, AND UNMANNED AERIAL VEHICLE

(71) Applicant: SZ DJI TECHNOLOGY CO., LTD., Shenzhen (CN)

(72) Inventors: Xun LI, Shenzhen (CN); Chunming WANG, Shenzhen (CN)

(21) Appl. No.: 16/897,003

(22) Filed: Jun. 9, 2020

Related U.S. Application Data
(63) Continuation of application No. PCT/CN2017/116989, filed on Dec. 18, 2017.

(51) Int. Cl. G01S 13/935; G01S 13/34; G01S 7/35

(52) U.S. Cl. CPC G01S 13/935; G01S 2007/356; G01S 7/352; G01S 13/34

(57) ABSTRACT

A radar-based ranging processing method includes obtaining a difference frequency signal of a radar, obtaining input spectrum amplitude data according to the difference frequency signal, obtaining, based on parallel processing, constant false alarm detection values each corresponding to one of spectrum amplitudes of the input spectrum amplitude data, obtaining a target frequency point according to the spectrum amplitudes and the corresponding constant false alarm detection values, and obtaining a distance value between the radar and an obstacle according to the target frequency point. For each spectrum amplitude, obtaining the corresponding constant false alarm detection value includes obtaining a neighboring value sequence corresponding to the spectrum amplitude and including neighboring values, performing simultaneous sorting on the neighboring values in pairs to obtain a sorted neighboring value sequence, and obtaining the constant false alarm detection value corresponding to the spectrum amplitude according to the sorted neighboring value sequence.

### CROSS-REFERENCE TO RELATED APPLICATION

This application is a continuation of International Application No. PCT/CN2017/116989, filed Dec. 18, 2017, the entire content of which is incorporated herein by reference.

### TECHNICAL FIELD

The present disclosure relates to information processing technology and, more particularly, to a radar-based ranging processing method and device, and an unmanned aerial vehicle (UAV).

### BACKGROUND

With fast development of science and technology, radar technology enters various fields of modern human life and has an indispensable important position. Continuous wave radar occupies an increasingly important position in various fields due to advantages of a high distance resolution, no detection dead zone, a strong anti-interference ability, etc. To measure a distance between the radar and an obstacle in real time, it is needed to process corresponding data based on data returned by the radar. Therefore, a ranging algorithm based on the continuous wave radar is developed.

In conventional technologies, the continuous wave radar ranging algorithm is usually implemented in form of software by using a central processing unit (CPU). Since the CPU can only process data in a serial manner, that is, only one piece of data can be processed at a time. Thus, when the radar ranging algorithm is implemented by using the CPU, a processing delay of the algorithm is relative long and far exceeds a delay of the radar returning data. Therefore, the radar returned data cannot be processed in real time, when the radar ranging algorithm is implemented by using the CPU, which leads to a low accuracy of a radar ranging value. Therefore, how to effectively improve the real-time performance of the radar ranging algorithm becomes an urgent technical problem.

### SUMMARY

In accordance with the disclosure, there is provided a radar-based ranging processing method. The method includes obtaining a difference frequency signal of a radar, obtaining input spectrum amplitude data according to the difference frequency signal, obtaining, based on parallel processing, constant false alarm detection values each corresponding to one of spectrum amplitudes of the input spectrum amplitude data, obtaining a target frequency point according to the spectrum amplitudes and the corresponding constant false alarm detection values, and obtaining a distance value between the radar and an obstacle according to the target frequency point. For each spectrum amplitude, obtaining the corresponding constant false alarm detection value includes obtaining a neighboring value sequence corresponding to the spectrum amplitude and including N neighboring values, performing simultaneous sorting on the N neighboring values in pairs for at most N times to obtain a sorted neighboring value sequence, and obtaining the constant false alarm detection value corresponding to the spectrum amplitude according to the sorted neighboring value sequence.

In accordance with the disclosure, there is provided a radar-based ranging processing device. The radar-based ranging processing device includes a memory and a processor. The memory stores program instructions that, when executed by the processor, cause the processor to obtain a difference frequency signal of a radar, obtain input spectrum amplitude data according to the difference frequency signal, obtain, based on parallel processing, constant false alarm detection values each corresponding to one of spectrum amplitudes of the input spectrum amplitude data, obtain a target frequency point according to the spectrum amplitudes and the corresponding constant false alarm detection values, and obtain a distance value between the radar and an obstacle according to the target frequency point. For each spectrum amplitude, to obtain the corresponding constant false alarm detection value, the processor is further caused to obtain a neighboring value sequence corresponding to the spectrum amplitude and including N neighboring values, perform simultaneous sorting on the N neighboring values in pairs for at most N times to obtain a sorted neighboring value sequence, and obtain the constant false alarm detection value corresponding to the spectrum amplitude according to the sorted neighboring value sequence.

In accordance with the disclosure, there is provided an unmanned aerial vehicle (UAV). The UAV includes a body, an arm extending from the body, and a power assembly mounted at the arm, a radar mounted at the body, and a radar-based ranging processing device mounted at the body. The radar-based ranging processing device is configured to obtain a difference frequency signal of a radar, obtain input spectrum amplitude data according to the difference frequency signal, obtain, based on parallel processing, constant false alarm detection values each corresponding to one of spectrum amplitudes of the input spectrum amplitude data, obtain a target frequency point according to the spectrum amplitudes and the corresponding constant false alarm detection values, and obtain a distance value between the radar and an obstacle according to the target frequency point. For each spectrum amplitude, to obtain the corresponding constant false alarm detection value, the radar-based ranging processing device is further configured to obtain a neighboring value sequence corresponding to the spectrum amplitude and including N neighboring values, perform simultaneous sorting on the N neighboring values in pairs for at most N times to obtain a sorted neighboring value sequence, and obtain the constant false alarm detection value corresponding to the spectrum amplitude according to the sorted neighboring value sequence.

### BRIEF DESCRIPTION OF THE DRAWINGS

FIG. 1 is a schematic flowchart of a radar-based ranging processing method according to an embodiment of the present disclosure.

FIG. 2A is a schematic diagram of a sorting algorithm for an even number of neighboring values according to an embodiment of the present disclosure.

FIG. 2B is a schematic diagram of a sorting algorithm for an odd number of neighboring values according to an embodiment of the present disclosure.

FIG. 3 is a schematic diagram for obtaining a neighboring value sequence according to an embodiment of the present disclosure.

FIG. 4 is a schematic diagram of an output data packet according to an embodiment of the present disclosure.

FIG. 5 is a schematic flowchart of spectrum refinement processing according to the present disclosure.

FIG. 6 is a schematic structural diagram of a radar-based ranging processing device according to an embodiment of the present disclosure.

FIG. 7 is a schematic structural diagram of a radar-based ranging processing device according to another embodiment of the present disclosure.

FIG. 8 is a schematic structural diagram of an unmanned aerial vehicle (UAV) according to an embodiment of the present disclosure.

### DETAILED DESCRIPTION OF THE EMBODIMENTS

To make purposes, technical solutions, and advantages of embodiments of the present disclosure clearer, the technical solutions in embodiments of the present disclosure are described in more detail with reference to drawings of embodiments of the disclosure. The described embodiments are only some embodiments of the disclosure not all the embodiments. Based on the embodiments of the disclosure, all other embodiments obtained by one of ordinary skill in the art without any creative effort are within the scope of the present disclosure.

In accordance with the present disclosure, there is provided a radar-based ranging processing method and device, and an unmanned aerial vehicle (UAV). A basic principle of radar ranging includes following processes. A carrier frequency signal transmitted by radar is modulated by using a certain modulation method, and the modulated carrier frequency signal is used as a transmission signal and a local oscillator signal. After the radar receives a target echo, an echo signal and the local oscillator signal are mixed, filtered, and amplified to obtain a difference frequency signal. The difference frequency signal is then analyzed in a frequency domain. A correspondence between a frequency shift and a delay of the echo signal can be used to obtain a distance between the radar and an obstacle. In some embodiments, the radar can be a continuous-wave radar.

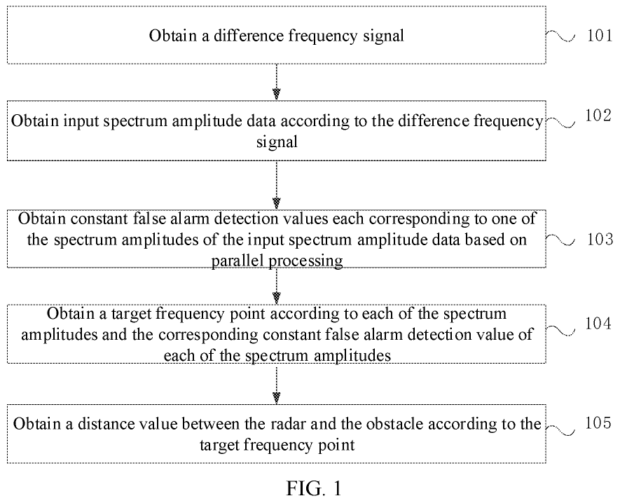

FIG. 1 is a schematic flowchart of a radar-based ranging processing method according to an embodiment of the present disclosure. The embodiment provides the radar-based ranging processing method, which is used to measure a distance between the radar and an obstacle to provide basis for a subsequent operation. As shown in FIG. 1, the method includes following processes.

At 101, a difference frequency signal is obtained.

In some embodiments, a to-be-processed object is the difference frequency signal obtained by mixing a transmitted signal and a received signal (i.e., echo signal) returned by a radio frequency front end of the radar. The difference frequency signal may be a difference frequency signal obtained with certain filtration and amplification after frequency mixing.

At 102, input spectrum amplitude data is obtained according to the difference frequency signal.

After the difference frequency signal is obtained, the input spectrum amplitude data is obtained according to the difference frequency signal.

The input spectrum amplitude data includes a plurality of spectrum amplitudes (also referred to as spectrum amplitude values). A specific number of included spectrum amplitudes can be set according to actual needs during a process of obtaining the input spectrum amplitude data according to the difference frequency signal.

For example, the input spectrum amplitude data is obtained by performing spectrum extraction to the difference frequency signal.

At 103, constant false alarm detection values each corresponding to one of the spectrum amplitudes of the input spectrum amplitude data are obtained based on parallel processing.

The obtaining method for each constant false alarm detection value includes obtaining a neighboring value sequence corresponding to the spectrum amplitude, simultaneously sorting N neighboring values of the neighboring value sequence in pairs (which requires at most N times to complete sorting the neighboring value sequence, where N is a positive integer), and obtaining the constant false alarm detection value corresponding to the spectrum amplitude according to the sorted neighboring value sequence.

In some embodiments, after the input spectrum amplitude data is obtained, the corresponding constant false alarm detection values for the spectrum amplitudes of the input spectrum amplitude data need to be determined. The constant false alarm detection values each corresponding to one of the spectrum amplitudes are obtained in parallel by using a method based on parallel processing.

For example, obtaining the constant false alarm detection values each corresponding to one of the spectrum amplitudes in parallel can be implemented based on a processor with a parallel processing feature, for example, implemented using a field-programmable gate array (FPGA) based on a parallel feature of the FPGA. The embodiments are not limited to this, and the processor may be another processor having a parallel processing function.

In some embodiments, by obtaining the constant false alarm detection values each corresponding to one of the spectrum amplitudes of the input spectrum amplitude data based on the parallel processing method, a data processing efficiency may be effectively increased, and a radar ranging delay is reduced, so as to improve a radar ranging accuracy.

In some embodiments, the specific method for obtaining each of the constant false alarm detection values may include obtaining a neighboring value sequence corresponding to the spectrum amplitude, simultaneously sorting N neighboring values of the neighboring value sequence in pairs (which requires at most N times to complete sorting the neighboring value sequence, where N is a positive integer), and obtaining the constant false alarm detection values each corresponding to one of the spectrum amplitudes according to the sorted neighboring value sequence.

In some embodiments, the neighboring value sequence corresponding to the spectrum amplitude is obtained by using a pre-configured parallel pipeline sorting algorithm. The constant false alarm detection value corresponding to the spectrum amplitude is obtained according to the sorted neighboring value sequence.

In some embodiments, the neighboring value sequence corresponding to the spectrum amplitude is a sequence of N neighboring spectrum amplitudes in the spectrum amplitude data that are before or after the spectrum amplitude. Each spectrum amplitude corresponds to a neighboring value sequence. After the neighboring value sequences corresponding to the spectrum amplitudes are obtained, the N neighboring spectrum amplitudes of each neighboring value sequence need to be sorted.

In some embodiments, the pre-configured parallel pipeline sorting algorithm can be used, that is, the N neighboring values of the neighboring value sequence are sorted simultaneously in pairs, and, at most by sorting for N times, sorting of the neighboring value sequence can be completed. Pipeline means that a sorting process can be divided into a plurality of stages. Parallel means that, for each stage, neighboring values of the neighboring value sequence are sorted simultaneously in pairs.

For example, for a neighboring value sequence having four neighboring values, i.e., a neighboring value sequence [A, B, C, D], the sorting process can be divided into 4 stages. At a first stage, A and B, and C and D are compared and sorted, e.g., in an ascending order, in parallel. Assume that A is greater than B, and C is greater than D, a sorting result of the first stage is [B, A, D, C]. The sequence [B, A, D, C] is entered as an input for sorting in a next stage.

In the embodiments, by simultaneously sorting the N neighboring values of the neighboring value sequence in pairs, sorting of the neighboring value sequence can be completed by sorting for at most N times. The processing delay is effectively reduced, and the accuracy of the radar ranging is further improved.

In the embodiments, not only a sorting process of each neighboring value sequence uses a parallel pipeline method, but also the sorting processes of respective neighboring value sequences can be performed in parallel, that is, the sorting process is being performed on each of the neighboring value sequences simultaneously. The processing delay can be further effectively reduced.

Once a sorted neighboring value sequence is obtained, the constant false alarm detection value corresponding to the spectrum amplitude corresponding to the sorted neighboring value sequence can be obtained according to the sorted neighboring value sequence.

For example, for each spectrum amplitude, according to a first preset threshold P, a P-th neighboring value is selected from the corresponding sorted neighboring value sequence, and the constant false alarm detection value corresponding to the spectrum amplitude is calculated and obtained according to a specific calculation formula.

At 104, according to each of the spectrum amplitudes and the corresponding constant false alarm detection value of each of the spectrum amplitudes, a target frequency point is obtained.

In some embodiments, after the corresponding constant false alarm detection value of each of the spectrum amplitudes is obtained, the target frequency point is searched for and obtained.

In some embodiments, a spectrum amplitude peak value search method is used, and a frequency point corresponding to the largest spectrum amplitude is obtained as the target frequency point.

At 105, according to the target frequency point, the distance value between the radar and the obstacle is obtained.

In some embodiments, after the target frequency point is obtained, the distance value between the radar and the obstacle can be obtained according to the target frequency point.

In the embodiments, through the method based on the parallel processing, the corresponding constant false alarm detection value of each spectrum amplitude of the input spectrum amplitude data is obtained. According to each spectrum amplitude and the corresponding constant false alarm detection value of each spectrum amplitude, the target frequency point is searched for and obtained. According to the target frequency point, the distance value between the radar and the obstacle is obtained. This method can increase the data processing efficiency and reduce the radar ranging delay, so as to improve the radar ranging accuracy. By further using the pre-configured parallel pipeline sorting algorithm, sorting is performed on the neighboring value sequence. According to the sorted neighboring value sequence, the constant false alarm detection value corresponding to the spectrum amplitude is obtained, so as to further reduce the processing delay and improve the radar ranging accuracy.

In some embodiments, simultaneously sorting the N neighboring values of the neighboring value sequence in pairs may include comparing the N neighboring values of the neighboring value sequence simultaneously in pairs and, for two neighboring values being compared, if the two neighboring values are determined to exchange positions according to a comparison result and a pre-configured sorting manner, exchanging the positions of the two neighboring values. As such, a first neighboring value sequence is obtained.

For example, for a neighboring value sequence [A, B, C, D], the first neighboring value is compared with the second neighboring value, and the third neighboring value is compared with the fourth neighboring value. That is, A is compared with B, and C is compared with D. Assume that A is greater than B, C is greater than D, and the sorting is in an ascending order. Then after the comparison, A exchanges position with B, and C exchange position with D. As such, a first neighboring value sequence [B, A, D, C] is obtained.

In some embodiments, completing sorting the neighboring value sequence by sorting for at most N times can include sending the first neighboring value sequence to the next stage for sorting, sorting the N neighboring values of the first neighboring value sequence simultaneously in pairs to obtain a second neighboring value sequence, and repeating the process until the N-th neighboring value sequence is obtained.

In some embodiments, simultaneously sorting the N neighboring values of the neighboring value sequence in pairs and completing sorting the neighboring value sequence by sorting for at most N times can include following processes.

According to the neighboring value sequence, N stages are obtained.

At a first stage, the N neighboring values of the neighboring value sequence are compared simultaneously in pairs. For two neighboring values being compared, if, according to a comparison result and the pre-configured sorting manner, the two neighboring values are determined to exchange positions, the positions of the two neighboring values are exchanged. A first neighboring value sequence is obtained and sent to a second stage.

At a j-th stage, N neighboring values of a (j−1)-th neighboring value sequence are compared simultaneously in pairs. For two neighboring values being compared, if, according to a comparison result and the pre-configured sorting manner, the two neighboring values are determined to exchange positions, the positions of the two neighboring values are exchanged. A j-th neighboring value sequence is obtained and sent to a (j+1)-th stage. j increases by 1, and the process is repeated until the N-th neighboring value sequence is obtained, where N and j are integers, j is greater than or equal to 2, and j is smaller than or equal to N.

For example, for a neighboring value sequence corresponding to a spectrum amplitude and having N neighboring values, a sorting process of the neighboring value sequence is divided into N stages. Each time after sorting at one stage is completed, an obtained result is sent to a next stage.

For example, a specific process of comparing the N neighboring values simultaneously in pairs at the t-th stage (t being an integer smaller than or equal to N) can include comparing i-th neighboring value X(i) and (i+1)-th neighboring value X(i+1) of the N neighboring values simultaneously in pairs, where i is an integer. In the t-th stage comparison, if N is an even number and t is an odd number, then i is equal to 1, 3, . . . , N-1; if N is an even number and t is an even number, then i is equal to 2, 4, . . . , N-2; if N is an odd number and t is an odd number, then i is equal to 1, 3, . . . , N-2; and if N is an odd number and t is an even number, then i is equal to 2, 4, . . . , N-1.

The above process can be repeated for each of the stages until the N-th stage. An obtained N-th neighboring value sequence is thus a sorted neighboring value sequence.

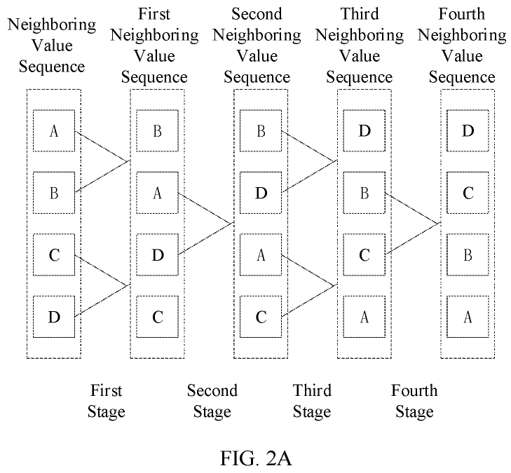

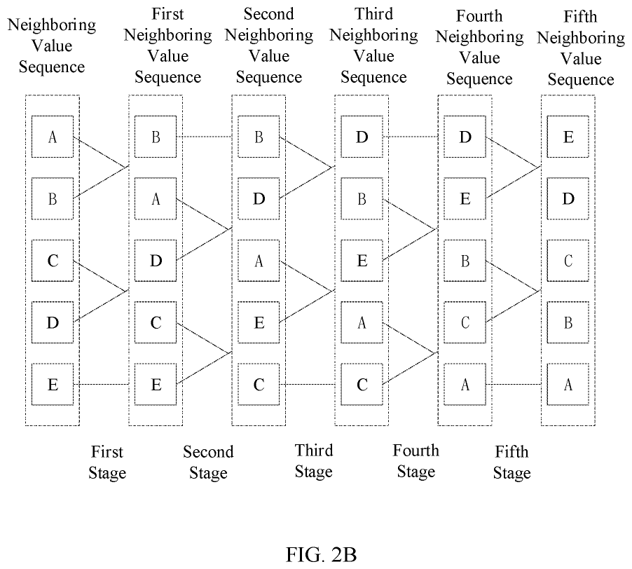

For example, FIG. 2A is a schematic diagram of a sorting algorithm of an even number of neighboring values according to an embodiment of the present disclosure. FIG. 2B is a schematic diagram of a sorting algorithm of an odd number of neighboring values according to an embodiment of the present disclosure.

As shown in FIG. 2A, assume that a sequence corresponding to a certain spectrum amplitude is [A, B, C, D], which includes four neighboring values, and is to be sorted in an ascending order. A sorting process includes following four stages.

At a first stage, the first neighboring value is compared with the second neighboring value, and the third neighboring value is compared with the fourth neighboring value of the neighboring value sequence [A, B, C, D]. That is, A is compared with B, and C is compared with D. If A is greater than B, C is greater than D, since a pre-configured sorting manner is in the ascending order, then after the comparison, A exchanges position with B, C exchanges position with D, and a first neighboring sequence [B, A, D, C] is obtained. The first neighboring value sequence [B, A, D, C] is sent to a second stage.

At the second stage, for the first neighboring value sequence [B, A, D, C], the second neighboring value is compared with the third neighboring value. That is, A is compared with D. If A is greater than D, A exchanges position with D after the comparison. A second neighboring value sequence [B, D, A, C] is obtained.

At a third stage, for the second neighboring value sequence [B, D, A, C], the first neighboring value is compared with the second neighboring value, and the third neighboring value is compared with the fourth neighboring value. That is, B is compared with D, and A is compared with C. If B is greater than D, and A is greater than C, then B exchanges position with D and A exchanges position with C after comparison. A third neighboring sequence [D, B, C, A] is obtained.

At a fourth stage, for the third neighboring sequence [D, B, C, A], the second neighboring value is compared with the third neighboring value. That is, B is compared with C. If B is greater than C, B exchanges position with C after comparison. A fourth neighboring value sequence [D, C, B, A] is obtained, which is a sorted neighboring value sequence.

As shown in FIG. 2B, if neighboring value sequence has an odd number of neighboring values, at odd number stages, the last neighboring value is not compared and is entered directly into a next stage. At even number stages, the first neighboring value is not compared and is entered directly into a next stage. The specific process is similar to the process when the number of neighboring values is an even number, which is not repeated here.

The sorting process of the neighboring value sequence requires a large amount of calculation and takes a long time. To reduce the time delay, a sorting algorithm structure based on a parallel pipeline structure of the above-described process is used, for example, a parallel processing feature and the pipeline structure of a FPGA can be used to dramatically reduce sorting calculation time during a constant false alarm detection process. The sorting algorithm for each group with N pieces of data is divided into N stages. In each stage, sizes of N/2 or N/2-1 pairs of data are compared simultaneously. After the comparisons, the data exchange positions according to the sizes of the data (sorting in an ascending or a descending order). The processed data is then sent to a next stage of the process through the pipeline structure. The sorting algorithm for each group with N pieces of data requires only N cycles to complete.

In some embodiments, according to the above-described sorted neighboring value sequence, obtaining the constant false alarm detection value corresponding to the spectrum amplitude may include 1) according to a first preset threshold P, obtaining a P-th neighboring value of the sorted neighboring value sequence and 2) according to the P-th neighboring value D(P), the number of the spectrum amplitudes in the input spectrum amplitude data NF (where NF is a positive integer), and a pre-configured constant false alarm probability, obtaining the constant false alarm detection value corresponding to the spectrum amplitude.

According to the P-th neighboring value D(P), the number of the spectrum amplitudes in the input spectrum amplitude data NF, and the pre-configured constant false alarm probability Pf, the following formula:

D_{cfar}=D(P)×2NF×(Pf^{exp((-1/2NF)}−1);

is used to obtain the constant false alarm detection value D_{cfar} corresponding to the spectrum amplitude.

In some embodiments, the first threshold P can be set according to practical experience. The pre-configured constant false alarm probability Pf is set according to an actual situation of a radar system.

In some embodiments, obtaining the neighboring value sequence corresponding to the spectrum amplitude may include selecting the N spectrum amplitudes in the spectrum amplitude data that are before or after and close to the spectrum amplitude to form the neighboring value sequence corresponding to the spectrum amplitude using the N spectrum amplitudes.

Obtaining the neighboring value sequence corresponding to the spectrum amplitude may include selecting T spectrum amplitudes in the spectrum amplitude data before and close to the spectrum amplitude and S spectrum amplitudes after and close to the spectrum amplitude, removing U spectrum amplitudes before and close to the spectrum amplitude and U spectrum amplitudes after and close to the spectrum amplitude to obtain N remaining spectrum amplitudes, and forming the neighboring value sequence corresponding to the spectrum amplitude using the N remaining spectrum amplitudes, where T, S, and U are non-negative integers, and N=T+S−2U.

In some embodiments, a rule for obtaining the neighboring value sequence may be selecting N/2 spectrum amplitudes before and close to a current spectrum amplitude and selecting N/2 spectrum amplitudes after and close to the current spectrum amplitude (when selecting, U pieces of data before and closest to the current spectrum amplitude and U pieces of data after and closest to the current spectrum amplitude need to be removed). If the number of spectrum amplitudes is less than N/2 before or after the current spectrum amplitude, more neighboring values can be selected from the opposite side to ensure a total number of neighboring values to be N, and a neighboring value sequence are formed using the N pieces of data.

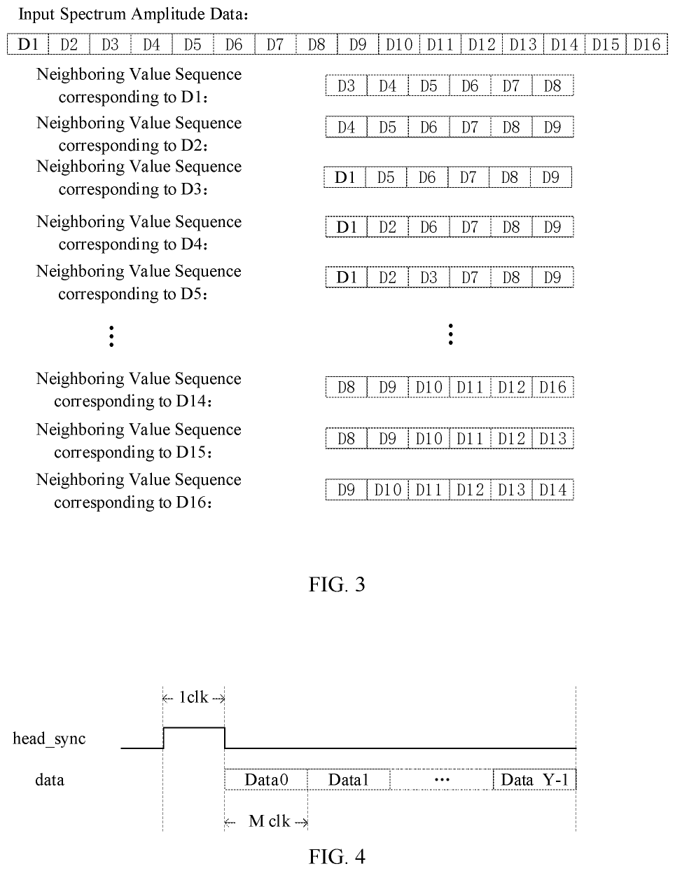

FIG. 3 is a schematic diagram of obtaining a neighboring value sequence according to an embodiment of the present disclosure. In this example, a number of spectrum amplitudes in the input spectrum amplitude data is 16, and U is 1. A number of neighboring values included in each neighboring value sequence is 6. For the 16 spectrum amplitudes, 16 corresponding neighboring value sequences need to be obtained. Di (i=1, 2, . . . , 16) represents an i-th spectrum amplitude.

In some embodiments, obtaining input spectrum amplitude data according to the different frequency signal (102 in FIG. 1) may include obtaining windowed data according to the difference frequency signal, obtaining the input spectrum amplitude data according to the windowed data.

In some embodiments, the obtaining the input spectrum amplitude data according to the windowed data may include performing Fourier transform on the windowed data to obtain transformed data, and obtaining the input spectrum amplitude data according to the transformed data.

In some embodiments, data containing squared input spectrum amplitude, also referred to as “squared input spectrum amplitude data,” may be used as the input spectrum amplitude data for further processing. According to the transformed data, calculation is performed on obtain the squared input spectrum amplitude data, which is used as the input spectrum amplitude data. That is, after the transformed data is obtained, only the squared input spectrum amplitude data needs to be calculated, and no square root operation is needed.

In some embodiments, the spectrum extraction only needs to obtain a squared spectrum amplitude value for a complex spectrum, and does not need a square root operation. Thus, because no square root operation is needed, computing resources and time required by the square root operation is saved. Therefore, consistent with the disclosure, an efficiency of the spectrum extraction is effectively improved, so that the real-time performance and the accuracy of the radar ranging are improved. By using the squared spectrum amplitude value as a basis for further extracting frequency information, a very similar effect can be achieved compared to the existing square root operation, while the computing amount is reduced.

In some embodiments, obtaining the windowed data according to the difference frequency signal may include obtaining an extracted output data packet according to the difference frequency signal and performing a window processing on the output data packet to obtain the windowed data.

For example, the window processing may be performed on the output data packet by using a Hanning window to obtain the windowed data.

In some embodiments, obtaining the extracted output data packet according to the difference frequency signal may include processing the difference frequency signal by using a predetermined format to obtain the corresponding output data packet. The output data packet includes a synchronization flag signal, Y data points, and a number of periods, in which the data points last, where Y is a positive integer.

In some embodiments, after the difference frequency signal of the radar is obtained, the difference frequency signal is processed by using the determined format to obtain the corresponding output data packet. The data packet may include the synchronization flag signal, the Y data points, and the number of periods, in which each data point lasts. Each output data packet is a set of data. The number of spectrum amplitudes in the above-obtained spectrum amplitude data is Y, i.e., the number of data points of a set of data.

For example, FIG. 4 is a schematic diagram of an output data packet according to an embodiment of the present disclosure. In FIG. 4, head_sync denotes the synchronization flag signal, “data” denotes the difference frequency signal, M denotes the number of periods, in which a data point lasts, and Y denotes the number of data points of a set of data. Specific set values of the number of lasting periods of the data points and the number of data points of a set of data may be adjusted according to user needs. The synchronization flag signal is output one time period ahead of valid data (i.e., the Y data points), and the lasting time is one time period, which is used to indicate a start of a new set of data to inform following processing when to start processing the new set of data.

In the embodiments, the difference frequency signal is processed by using the determined format, so that a processor can support a random unexpected data processing function. The processor not only can process radar ranging data with a continuous regular cycle, but also can process random unexpected radar ranging data with an irregular cycle.

In some embodiments, performing the window processing on the output data packet to obtain the windowed data may include traversing the Y data points to obtain a maximum value and a minimum value, determining a corresponding fluctuation range R1 of the Y data points according to the maximum value and the minimum value, determining a dynamic adjustment factor R2/R1 according to the fluctuation range R1 and a pre-configured fluctuation range R2, determining a final window function value according to an initially configured window function and the dynamic adjustment factor, and performing the window processing on the Y data points according to the window function value to obtain the windowed data.

In some embodiments, the difference between the maximum value and the minimum value is the corresponding fluctuation range R1 of the Y data points.

In some embodiments, the pre-configured fluctuation range R2 may be configured according to an actual situation of the radar system.

In some embodiments, the start of the new set of data is identified according to the synchronization flag signal of the output data packet, the Y data points after the synchronization flag signal are obtained, and the window processing is performed on the Y data points. Performing the window processing means multiplying the input data (i.e., the Y data points) with the window function. Therefore, the window operation may change amplitudes of the data, which may cause a data overflow for a very large signal, and hence reduce a dynamic range of the signal. Thus, a mechanism that can dynamically adjust a ratio of the window function according to the fluctuation range of the signal is provided, such that the windowed signal does not overflow, and the dynamic range of the signal is ensured.

A product of the initially configured window function and the dynamic adjustment factor is used as the final window function value. The Y data points are multiplied by the window function value to implement the window processing to obtain the windowed data.

In some embodiments, spectrum refinement is performed on the target frequency point obtained at 104. The process includes performing the spectrum refinement on the target frequency point, obtaining a first target frequency point according to a refinement result, and using the first target frequency point as the target frequency point. In some embodiments, the process may include obtaining the windowed data, performing spectrum refinement on the target frequency point according to the windowed data, and obtaining the first target frequency point according to the refinement result.

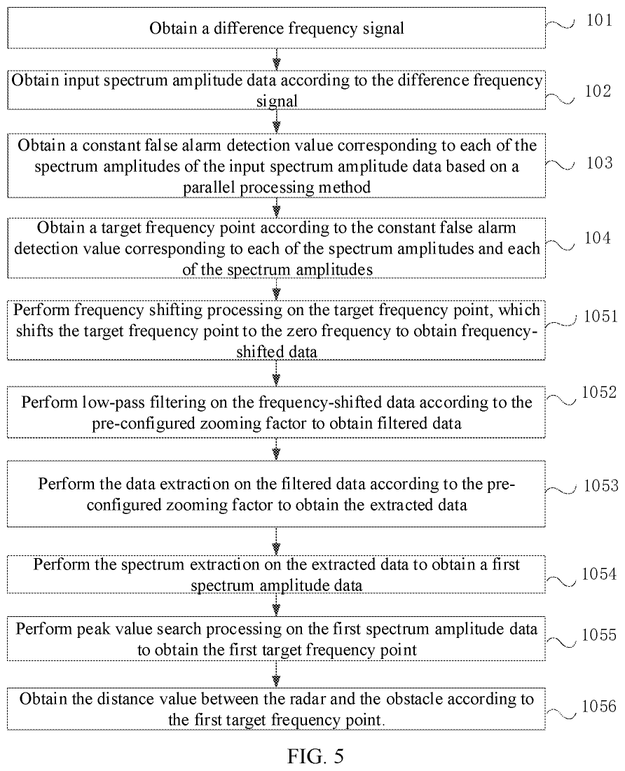

FIG. 5 is a schematic diagram of spectrum refinement according to some embodiments of the present disclosure. As shown in FIG. 5, the above-described process 105 further includes following processes.

At 1051, frequency shifting processing is performed on the target frequency point, which shifts the target frequency point to zero frequency to obtain frequency-shifted data.

In some embodiments, a digitally controlled oscillator can be used to generate a complex signal whose frequency is the target frequency, and the orthogonal complex signal is multiplied by the windowed data to move the target frequency point of the windowed data to the zero frequency to obtain the frequency-shifted data. The windowed data needs to be obtained as a to-be-processed object.

At 1052, low-pass filtering is performed on the frequency-shifted data according to the pre-configured zooming factor to obtain filtered data.

In some embodiments, according to the pre-configured zooming factor of the spectrum, signals other than target spectra (denoted as B2) of original spectra (i.e., frequency shifted data, denoted as B1) are filtered out. The pre-configured zooming factor (denoted as D) can be set by the user according to the ranging accuracy, and the relationship between the pre-configured zooming factor and the ranging accuracy is D=B1/B2. Since the low-pass filtering operation generates a group time delay effect, to avoid a mutual influence between the two adjacent sets of data, after each set of effective filtered data is output, the synchronization flag signal of each set of data is used to clear a cache register of a circuit to eliminate the influence between the two adjacent sets of data.

At 1053, data extraction is performed on the filtered data according to the pre-configured zooming factor to obtain the extracted data.

In some embodiments, for the filtered data, only one data point is selected for every interval of D (i.e., zooming factor) data points, and zeros are added after all the selected data to maintain the total number of data points of each set of data the same.

At 1054, the spectrum extraction is performed on the extracted data to obtain first spectrum amplitude data, where the first spectrum amplitude data is also referred to as extracted spectrum amplitude data.

The spectrum extraction process is the same as the above-described spectrum extraction process, which is not repeated here.

At 1055, peak value search processing is performed on the first spectrum amplitude data to obtain the first target frequency point, where the first target frequency point is also referred to as a processed target frequency point.

The first target frequency point of the largest first spectrum amplitude is extracted from the refined frequency points.

At 1056, the distance value between the radar and the obstacle is obtained according to the first target frequency point.

In some embodiments, the first frequency point F₁ is obtained according to the refinement result and used as the final target frequency point. According to the first target frequency point F₁, a pre-configured light speed C, a pre-configured period T of a radar modulation signal, and a pre-configured bandwidth of the radar modulation signal, the formula:

$$R = {F}_{1} \times \frac{C \times T}{2 B} ;$$

is used to obtain the distance value between the radar and the obstacle.

In some embodiments, after the spectrum refinement, the obtained first target frequency point is used as the final frequency point to calculate the distance between the radar and the obstacle to further improve the radar ranging accuracy.

In some embodiments, performing the data extraction on the filtered data according to the pre-configured zooming factor to extract the data includes extracting a data point for every interval of D data points, and adding zeros after the extracted data points, such that a number of frequency points of the extracted data is the same as the number of frequency points of the filtered data.

In some embodiments, obtaining the target frequency point according to each of the spectrum amplitudes and the corresponding constant false alarm detection value of each of the spectrum amplitudes (104 in FIG. 1) may include obtaining the target spectrum amplitudes satisfying a pre-configured condition according to each spectrum amplitude and the corresponding constant false alarm detection value of each of the spectrum amplitude, obtaining a largest target spectrum amplitude from the target spectrum amplitudes, and using the frequency point corresponding to the largest target spectrum amplitude as the target frequency point.

In some embodiments, the pre-configured condition is that the target spectrum amplitude is greater than a spectrum amplitude therebefore, greater than a spectrum amplitude thereafter, and greater than the constant false alarm detection value corresponding to the target spectrum amplitude.

In some embodiments, obtaining the distance value between the radar and the obstacle according to the target frequency point (105 in FIG. 1) may include obtaining the distance value between the radar and the obstacle according to the first target frequency point F, the pre-configured light speed C, the pre-configured period T of the radar modulation signal, and the pre-configured bandwidth of the radar modulation signal, using the formula:

$$R = F \times \frac{C \times T}{2 B} .$$

In some embodiments, the radar modulation signal may be a triangle wave, a sawtooth wave, or a sine wave. For different modulation signals, different corresponding distance formulas can be used to obtain the distance value between the radar and the obstacle, which are not limited here.

In some embodiments, the radar and the obstacle can be stationary relative to each other or moving relative to each other, which is not limited here.

In some embodiments, the radar ranging is implemented based on the parallel processing and the pipeline structure, which greatly improves the signal processing efficiency and reduces the processing time delay to improve the radar ranging accuracy.

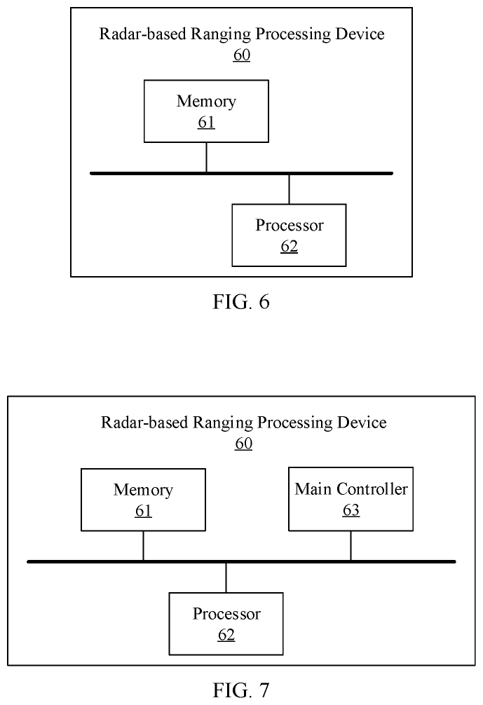

FIG. 6 is a schematic diagram of a radar-based ranging processing device 60 according to an embodiment of the present disclosure. As shown in FIG. 6, the radar-based ranging processing device 60 includes a memory 61 and a processor 62. The processor 62 may be a field-programmable gate array (FPGA), or may be another processor with a parallel processing feature and a pipeline feature, such as a central processing unit (CPU), a processor combined with a digital signal processor (DSP), etc.

The memory 61 is configured to store program instructions.

The processor 62 is configured to call the program instructions stored in the memory to obtain the radar difference frequency signal, obtain the input spectrum amplitude data according to the difference frequency signal, obtain the constant false alarm detection values each corresponding to one of the spectrum amplitudes of the input spectrum amplitude data based on the parallel processing, search for and obtain the target frequency point according to each of the spectrum amplitudes and the corresponding constant false alarm detection value of each of the spectrum amplitudes, and obtain the distance value between the radar and the obstacle according to the target frequency point. The method for obtaining each of the constant false alarm detection values includes obtaining the neighboring value sequence corresponding to the spectrum amplitude, simultaneously sorting N neighboring values of the neighboring value sequence in pairs, completing sorting the neighboring value sequence by sorting for at most N times, and obtaining the constant false alarm detection value corresponding to the spectrum amplitude according to the sorted neighboring value sequence.

In some embodiments, the processor 62 is configured to compare the N neighboring values of the neighboring value sequence simultaneously in pairs, and for two neighboring values being compared, if the two neighboring values are determined to exchange positions according to a comparison result and a pre-configured sorting manner, exchange the positions of the two neighboring values. As such a first neighboring value sequence is obtained.

In some embodiments, the processor 62 is configured to send the first neighboring value sequence to the next stage for sorting, sort the N neighboring values of the first neighboring value sequence simultaneously in pairs to obtain a second neighboring value sequence, and repeat the process until the N-th neighboring value sequence is obtained.

In some embodiments, the processor 62 is configured to perform the following processes.

N stages are obtained according to the neighboring value sequence.

At a first stage, the N neighboring values of the neighboring value sequence are compared simultaneously in pairs. For the two neighboring values being compared, if according to the comparing result and the pre-configured sorting manner, the two neighboring values are determined to exchange the positions, the positions of the two neighboring values are exchanged. The first neighboring value sequence is obtained and sent to a second stage.

At the j-th stage, the N neighboring values of the (j−1)-th neighboring value sequence are compared simultaneously in pairs. For two neighboring values being compared, if according to the comparing result and the pre-configured sorting manner, the two neighboring values are determined to exchange positions, the positions of the two neighboring values are exchanged. The j-th neighboring value sequence is obtained and sent to the (j+1)-th stage. j increases by 1, and the process is repeated until the N-th neighboring value sequence is obtained, where N and j are integers, j is greater than or equal to 2, and j is smaller than or equal to N.

In some embodiments, the processor 62 is configured to perform following processes.

At the t-th stage, the i-th neighboring value X(i) and the (i+1)-th neighboring value X(i+1) of the N neighboring values are compared simultaneously in pairs, where i is an integer. In the t-th stage comparison, if N is an even number and t is an odd number, then i is equal to 1, 3, . . . , N-1; if N is an even number and t is an even number, then i is equal to 2, 4, . . . , N-2; if N is an odd number and t is an odd number, then i is equal to 1, 3, . . . , N-2, and if N is an odd number and t is an even number, then i is equal to 2, 4, . . . , N-1.

In some embodiments, the processor 62 is configured to, according to a first preset threshold P, obtain a P-th neighboring value of the sorted neighboring value sequence and, according to the P-th neighboring value D(P), NF spectrum amplitudes of the sorted neighboring value sequence, and a pre-configured constant false alarm probability, obtain the constant false alarm detection value corresponding to the spectrum amplitude.

In some embodiments, the processor 62 is configured to select the T spectrum amplitudes in the spectrum amplitude data before and close to the spectrum amplitude and the S spectrum amplitudes after and close to the spectrum amplitude, remove the U spectrum amplitudes before and close to the spectrum amplitude and the U spectrum amplitudes after and close to the spectrum amplitude to obtain N remaining spectrum amplitudes, and form the neighboring value sequence corresponding to the spectrum amplitude using the N remaining spectrum amplitudes, where N=T+S−2U.

In some embodiments, the processor 62 is configured to obtain windowed data according to the difference frequency signal and obtain the input spectrum amplitude data according to the windowed data.

In some embodiments, the processor 62 is configured to perform Fourier transform on the windowed data to obtain the transformed data and obtain the input spectrum amplitude data according to the transformed data.

In some embodiments, the processor 62 is configured to, according to the transformed data, calculate and obtain the squared input spectrum amplitude values and use the squared input spectrum amplitude values as the input spectrum amplitude data.

In some embodiments, the processor 62 is configured to obtain the extracted output data packet according to the difference frequency signal and perform the window processing on the output data packet to obtain the windowed data.

In some embodiments, the processor 62 is configured to process the difference frequency signal by using the pre-determined format to obtain the corresponding output data packet, where the output data packet includes the synchronization flag signal, the Y data points, and the number of periods in which the data point lasts.

In some embodiments, the processor 62 is configured to traverse the Y data points to obtain the maximum value and the minimum value, determine the corresponding fluctuation range R1 of the Y data points according to the maximum value and the minimum value, determine the dynamic adjustment factor R2/R1 according to the fluctuation range R1 and the pre-configured fluctuation range R2, determine the final window function value according to the initially configured window function and the dynamic adjustment factor, and perform window processing on the Y data points according to the window function value to obtain the windowed data.

In some embodiments, the processor 62 is configured to perform the spectrum refinement on the target frequency points, obtain the first target frequency point according to the refinement result, and use the first target frequency point as the target frequency point.

In some embodiments, the processor 62 is configured to obtain the windowed data, perform the spectrum refinement on the target frequency point according to the windowed data, and obtain the first target frequency point according to the refinement result.

In some embodiments, the processor 62 is configured to perform frequency shifting processing on the target frequency point, which shifts the target frequency point to the zero frequency to obtain the frequency-shifted data, perform the low-pass filtering on the frequency-shifted data according to the pre-configured zooming factor to obtain the filtered data, perform the data extraction on the filtered data according to the pre-configured zooming factor to obtain the extracted data, perform the spectrum extraction on the extracted data to obtain the first spectrum amplitude data, perform the peak value search processing on the first spectrum amplitude data to obtain the first target frequency point, and obtain the distance value between the radar and the obstacle according to the first target frequency point. In some embodiments, the processor 62 is configured to extract one data point for every interval of the D data points, and add zeros after the selected data, such that the number of frequency points of the extracted data is the same as the number of frequency points of the filtered data.

In some embodiments, the processor 62 is configured to obtain the target spectrum amplitudes satisfying the pre-configured condition according to each of the spectrum amplitudes and the corresponding constant false alarm detection value of each of the spectrum amplitudes, obtain a largest target spectrum amplitude from the target spectrum amplitudes, and use the frequency point corresponding to the largest target spectrum amplitude as the target frequency point. In some embodiments, the pre-configured condition is that the target spectrum amplitude is greater than a spectrum amplitude therebefore, greater than a spectrum amplitude thereafter, and greater than the constant false alarm detection value corresponding to the target spectrum amplitude.

In some embodiments, the processor 62 is configured to obtain the distance value between the radar and the obstacle according to the first target frequency point F, the pre-configured light speed C, the pre-configured period T of the radar modulation signal, and the pre-configured bandwidth of the radar modulation signal.

In some embodiments, the processor may be a processor consisted of a field-programmable gate array (FPGA).

FIG. 7 is a schematic diagram of an example of the radar-based ranging processing device 60 according to another embodiment of the present disclosure. As shown in FIG. 7, in some embodiments, the radar-based ranging processing device 60 further includes a main controller 63.

The processor 62 may also include a cache.

The cache is configured to exchange data and control information between the processor and the main controller.

The cache includes a control logical circuit, a first cache, and a second cache.

The control logical circuit is configured to control a read operation of the first cache and a write operation of the second cache.

The main controller 63 is configured to control a write operation of the first cache and a read operation of the second cache.

The radar-based ranging processing device provided by the embodiments is configured to implement the radar ranging based on the parallel processing and pipeline structure to obtain the distance value between the radar and the obstacle, which improves processing efficiency and reduces processing delay, so as to improve the radar ranging accuracy. The cache is configured as a dual cache structure, and the control logical circuit of the cache controls the read operation of the first cache and the write operation of the second cache. The main controller different from the processor controls the write operation of the first cache and the read operation of the second cache. Read and write conflicts between the control logic circuit of the cache and the external main controller are avoided, such that the communication between the processor and the external main controller becomes smoother.

In the embodiments, the device can be configured to execute the technical solutions of the above-described various method embodiments of the present disclosure. The implementation principles and the technical effects are similar, which are not repeated here.

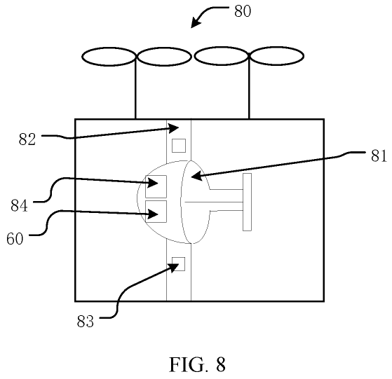

FIG. 8 is a schematic structural diagram of an unmanned aerial vehicle (UAV) 80 according to an embodiment of the present disclosure. As shown in FIG. 8, the UAV 80 includes a body 81, arms 82 extending from the body, power assemblies 83 mounted at the arm, a radar 84, and a radar-based ranging processing device 60 provided by any one of the above-described embodiments.

The radar and devices are all arranged at the body.

Those of skill in the art should understand that all or a part of processes of the above-described method embodiments may be implemented through hardware related to program instructions. The program may be stored in a computer-readable storage medium. When the program is executed, the processes of the above-described method embodiments are executed. The storage medium includes read-only memory (ROM), random access memory (RAM), magnetic disk, CD-ROM, or various media which can store program instructions.

The above-described embodiments are merely used to describe the technical solutions of the present disclosure but do not limit the present disclosure. Although the present disclosure is described in detail with reference to the various embodiments, those of ordinary skill in the art should understand that modifications can be made to the technical solutions described in the various embodiments or equivalently replacements can be made to some or all of technical features. These modifications or replacements do not cause the essence of the corresponding technical solutions to depart from the scope of the technical solutions of the embodiments of the present disclosure.

What is claimed is:

1. A radar-based ranging processing method comprising:
obtaining a difference frequency signal of a radar;
obtaining input spectrum amplitude data according to the difference frequency signal;
obtaining, based on parallel processing, constant false alarm detection values each corresponding to one of spectrum amplitudes of the input spectrum amplitude data, wherein for each spectrum amplitude, obtaining the corresponding constant false alarm detection value includes:
obtaining a neighboring value sequence corresponding to the spectrum amplitude, the neighboring value sequence including N neighboring values, N being a positive integer;
performing simultaneous sorting on the N neighboring values in pairs for at most N times to obtain a sorted neighboring value sequence; and
obtaining the constant false alarm detection value corresponding to the spectrum amplitude according to the sorted neighboring value sequence;
obtaining a target frequency point according to the spectrum amplitudes and the corresponding constant false alarm detection values; and
obtaining a distance value between the radar and an obstacle according to the target frequency point.

2. The method of claim 1, wherein performing simultaneous sorting on the N neighboring values in pairs includes:
obtaining a first neighboring value sequence by simultaneously comparing the N neighboring values of the neighboring value sequence in pairs and performing position exchange for each pair of neighboring values that are determined to exchange positions according to a comparison result and a pre-configured sorting manner.

3. The method of claim 2, wherein performing simultaneous sorting on the N neighboring values in pairs for at most N times includes:
sending the first neighboring value sequence to a next stage for sorting;
simultaneously sorting the N neighboring values of the first neighboring value sequence in pairs to obtain a second neighboring value sequence; and
repeating until an N-th neighboring value sequence is obtained.

4. The method of claim 1, wherein performing simultaneous sorting on the N neighboring values in pairs for at most N times includes:
obtaining N stages according to the neighboring value sequence;
at a first stage:
obtaining a first neighboring value sequence by simultaneously comparing the N neighboring values of the neighboring value sequence in pairs and performing position exchange for each pair of neighboring values that are determined to exchange positions according to a comparison result and a pre-configured sorting manner; and
sending the first neighboring sequence to a second stage; and
at a j-th stage, j being an integer greater than or equal to 2 and smaller than or equal to N:
obtaining a j-th neighboring value sequence by simultaneously comparing the N neighboring values of a (j−1)-th neighboring value sequence in pairs and performing position exchange for each pair of neighboring values that are determined to exchange positions according to a comparison result and the pre-configured sorting manner;
sending the j-th neighboring value sequence to a (j+1)-th stage; and
repeating until an N-th neighboring value sequence is obtained.

5. The method of claim 1, wherein simultaneously comparing the N neighboring values in pairs includes:
simultaneously comparing i-th neighboring value X(i) with (i+1)-th neighboring value X(i+1) of the N neighboring values in pairs, i being an integer, wherein at a t-th stage comparison, t being an integer smaller than or equal to N:
if N is an even number and t is an odd number, then i is equal to 1, 3, . . . , N-1;
if N is an even number and t is an even number, then i is equal to 2, 4, . . . , N-2;
if N is an odd number and t is an odd number, then i is equal to 1, 3, . . . , N-2; and
if N is an odd number and t is an even number, then i is equal to 2, 4, . . . , N-1.

6. The method of claim 1, wherein obtaining the constant false alarm detection value corresponding to the spectrum amplitude according to the sorted neighboring value sequence includes:
obtaining a P-th neighboring value of the sorted neighboring value sequence according to a threshold P, P being a positive integer; and
obtaining the constant false alarm detection value corresponding to the spectrum amplitude according to the P-th neighboring value, a number of spectrum amplitudes of the input spectrum amplitude data, and a pre-configured constant false alarm probability.

7. The method of claim 1, wherein obtaining the neighboring value sequence corresponding to the spectrum amplitude includes:
selecting N spectrum amplitudes before or after and close to the spectrum amplitude from the spectrum amplitude data; and
forming the neighboring value sequence corresponding to the spectrum amplitude using the N spectrum amplitudes.

8. The method of claim 7, wherein selecting the N spectrum amplitudes before or after and close to the spectrum amplitude from the spectrum amplitude data includes:
selecting T spectrum amplitudes before and close to the spectrum amplitude from the spectrum amplitude data;
selecting S spectrum amplitudes after and close to the spectrum amplitude from the spectrum amplitude data; and
removing U spectrum amplitudes before and close to the spectrum amplitude and U spectrum amplitudes after and close to the spectrum amplitude to obtain the N spectrum amplitudes;
wherein T, S, and U are non-negative integers, and N=T+S−2U.

9. The method of claim 1, wherein obtaining the input spectrum amplitude data according to the difference frequency signal includes:
obtaining windowed data according to the different frequency signal; and
obtaining the input spectrum amplitude data according to the windowed data.

10. The method of claim 9, wherein obtaining the input spectrum amplitude data according to the windowed data includes:
performing Fourier transformation on the windowed data to obtain transformed data; and
obtaining the input spectrum amplitude data according to the transformed data.

11. The method of claim 10, wherein obtaining the input spectrum amplitude data according to the transformed data includes:
obtaining squared input spectrum amplitude data according to the transformed data; and
using the squared input spectrum amplitude data as the input spectrum amplitude data.

12. The method of claim 9, wherein obtaining the windowed data according to the difference frequency signal includes:
extracting an output data packet according to the difference frequency signal; and
performing window processing on the output data packet to obtain the windowed data.

13. The method of claim 12, wherein extracting the output data packet according to the difference frequency signal includes:
processing the difference frequency signal by using a pre-determined format to obtain the output data packet, the output data packet including a synchronization flag signal, a plurality of data points, and a number of periods in which the data points last.

14. The method of claim 13, wherein performing the window processing on the output data packet to obtain the windowed data includes:
traversing the plurality of data points to obtain a maximum value and a minimum value;
determining a fluctuation range of the plurality of data points according to the maximum value and the minimum value;
determining a dynamic adjustment factor as a ratio of a pre-configured fluctuation range to the determined fluctuation range;
determining a window function value according to an initially configured window function and the dynamic adjustment factor; and
performing the window processing on the plurality of data points to obtain the windowed data according to the window function value.

15. The method of claim 9, further comprising:
performing spectrum refinement on the target frequency point to obtain a refined target frequency point;
wherein obtaining the distance value according to the target frequency point includes obtaining the distance according to the refined target frequency point.

16. The method of claim 15, wherein performing the spectrum refinement on the target frequency point includes:
performing the spectrum refinement on the target frequency point according to the windowed data.

17. The method of claim 1, wherein obtaining the distance value between the radar and the obstacle according to the target frequency point includes:
performing frequency shifting processing on the target frequency point to shift the target frequency point to zero frequency, to obtain frequency shifted data;
performing low-pass filtering on the frequency-shifted data according to a pre-configured zooming factor to obtain filtered data;
performing data extraction on the filtered data according to the pre-configured zooming factor to obtain extracted data;
performing spectrum extraction processing on the extracted data to obtain extracted spectrum amplitude data;
performing peak search on the extracted spectrum amplitude data to obtain a processed target frequency point; and
obtaining the distance value between the radar and the obstacle according to the processed target frequency point.

18. The method of claim 17, wherein performing the data extraction on the filtered data to obtain the extracted data according to the pre-configured zooming factor includes:
extracting one data point for every interval of D data points; and
adding zeros after the extracted data points such that a number of frequency points of the extracted data is the same as a number of frequency points of the filtered data.

19. A radar-based ranging processing device comprising:
a processor;
a memory storing program instructions that, when executed by the processor, cause the processor to:
obtain a difference frequency signal of a radar;
obtain input spectrum amplitude data according to the difference frequency signal;
obtain, based on parallel processing, constant false alarm detection values each corresponding to one of spectrum amplitudes of the input spectrum amplitude data, wherein for each spectrum amplitude, the corresponding constant false alarm detection value is obtained by:
obtaining a neighboring value sequence corresponding to the spectrum amplitude, the neighboring value sequence including N neighboring values, N being a positive integer;
performing simultaneous sorting on the N neighboring values in pairs for at most N times to obtain a sorted neighboring value sequence; and
obtaining the constant false alarm detection value corresponding to the spectrum amplitude according to the sorted neighboring value sequence;
obtain a target frequency point according to the spectrum amplitudes and the corresponding constant false alarm detection values; and
obtain a distance value between the radar and an obstacle according to the target frequency point.

20. An unmanned aerial vehicle (UAV) comprising:
a body;
an arm extending from the body;
a power assembly mounted at the arm;
a radar mounted at the body; and
a radar-based ranging processing device mounted at the body and configured to:
obtain a difference frequency signal of a radar;
obtain input spectrum amplitude data according to the difference frequency signal;
obtain, based on parallel processing, constant false alarm detection values each corresponding to one of spectrum amplitudes of the input spectrum amplitude data, wherein for each spectrum amplitude, the corresponding constant false alarm detection value is obtained by:
obtaining a neighboring value sequence corresponding to the spectrum amplitude, the neighboring value sequence including N neighboring values, N being a positive integer;
performing simultaneous sorting on the N neighboring values in pairs for at most N times to obtain a sorted neighboring value sequence; and
obtaining the constant false alarm detection value corresponding to the spectrum amplitude according to the sorted neighboring value sequence;
obtain a target frequency point according to the spectrum amplitudes and the corresponding constant false alarm detection values; and
obtain a distance value between the radar and an obstacle according to the target frequency point.
